(19) United States
(12) Patent Application Publication
(10) Pub. No.: US 2012/0234534 A1
(43) Pub. Date: Sep. 20, 2012

(54) Wellhead Ball Launch and Detection System and Method

(76) Inventors: Ronnie D. Hughes, College Station, TX (US); Harold Beeson, College Station, TX (US); Ron Gasch, Bryan, TX (US)

(21) Appl. No.: 13/049,143

(22) Filed: Mar. 16, 2011

(51) Int. Cl. E21B 47/09; G06K 7/01; E21B 33/13

(52) U.S. Cl. 166/255.1; 166/75.15; 235/375

(57) ABSTRACT

A wellhead ball launch detection system includes a detectable ball, and a detector, attachable to a wellhead, having an aperture, configured to detect passage of the detectable ball therethrough.

### BACKGROUND

1. Field of the Disclosure

The present disclosure relates generally to tools and methods for use in oil and gas wells, and more specifically, to a system for detecting the downhole launch of balls for ball seat-actuated devices in a well casing sleeve.

2. Description of the Related Art

The casing of a hydrocarbon well can include various structures that may be used for stimulating multiple production zones in the wellbore. Such structures can include ball-actuated devices. For example, the casing can include modules spaced at intervals along the casing, each module having a ball-actuated sliding sleeve that can be selectively opened to allow stimulation and/or treatment of the well formation at the location of the sleeve, such as through fracturing. To stimulate and/or treat multiple zones within a wellbore, a series of balls of varying diameter can be introduced or launched into the well casing and pumped downward into the well. When the ball reaches a ball seat having a corresponding size, it stops and effectively seals the well at that position, allowing differential fluid pressure to push the ball and actuate the ball seat-actuated device. Once opened, the zone adjacent to the ball seat can be stimulated and/or treated. A second ball may then be launched to repeat the process in a second zone.

One potential challenge associated with launching balls into a well is that it can be difficult to confirm that a ball has actually been launched. The launching of balls is often effected by opening an insertion valve at the wellhead, and manually inserting a ball of a selected diameter, then closing the valve. Another valve is then opened, which allows the ball to enter the wellhead, and be pumped to the corresponding ball seat location. However, it is possible for the ball to become trapped or stuck at some point in the well head, without actually launching. Under current practice, the typical mode for confirming launch of a ball is to detect a subsequent fluid pressure increase in the well, indicating that the ball has sealed its intended ball seat. However, if the pressure does not increase as anticipated, there can be several possible causes, only one of which is failure of the ball to launch. This adds uncertainty and cost to the process of stimulating and/or treating a well. Moreover, direct confirmation of whether the ball launched is only possible by dropping the well fluid pressure, so that the insertion valve can be opened for visual inspection. This process is time-consuming, and therefore increases costs.

The present disclosure is directed to overcoming, or at least reducing the effects of, one or more of the issues set forth above.

### SUMMARY

The following presents a summary of the disclosure in order to provide an understanding of some aspects disclosed herein. This summary is not an exhaustive overview, and it is not intended to identify key or critical elements of the disclosure or to delineate the scope of the invention as set forth in the appended claims.

In accordance with one embodiment thereof, the present disclosure provides a wellhead ball launch detection system, including a detectable ball, and a detector, attachable to a wellhead, having an aperture, configured to detect passage of the detectable ball therethrough.

In one embodiment, the detectable ball can include a radio frequency identification (RFID) tag, and the detector can be an RFID detector. In one embodiment, the RFID tag can be programmed with data representing at least one of the size of the ball, the weight of the ball, and the date of manufacture of the ball.

In one embodiment, the wellhead ball launch system further includes a ball launch tool, disposed above the detector, adapted to receive at least one ball for introduction into the wellhead. In one embodiment the ball launch tool includes an openable chamber, adapted for introduction of a single ball into the wellhead. In another embodiment, the ball launch tool includes a vessel, having an internal chamber in fluid communication with the aperture of the detector, and a plurality of selectively releasable ball holders, disposed in a substantially vertical array within the internal chamber, each ball holder being configured to selectively retain a detectable ball in ascending order of ball diameter.

In accordance with another aspect thereof, the present disclosure can be described as providing a wellhead ball launch system including a generally upright, first pressurizable tool, having an internal chamber and a plurality of selectively releasable ball holders, and a detector, below all of the selectively releasable ball holders. The first pressurizable tool is attachable to a wellhead and has an openable top. The selectively releasable ball holders are arranged in a substantially vertical array within the internal chamber, and configured to retain a first plurality of detectable balls of varying diameter, in ascending order of ball diameter. The detector includes an aperture and is configured to detect passage of the detectable balls therethrough.

In accordance with another aspect thereof, the present disclosure provides a method for launching balls into a wellhead. The method includes introducing a detectable ball into a wellhead tool, and detecting passage of the detectable ball from the tool, thereby confirming that the ball has dropped into the wellhead.

In one embodiment, introducing the detectable ball into the wellhead tool can include sequentially dropping detectable balls from a ball launch tool containing a plurality of detectable balls in ascending diametrical order.

These and other embodiments of the present application will be discussed more fully in the description. The features, functions, and advantages can be achieved independently in various embodiments of the claimed invention, or may be combined in yet other embodiments.

### BRIEF DESCRIPTION OF THE DRAWINGS

FIG. 1 illustrates a portion of a cemented wellbore completion, having a ball-actuated sleeve, and showing the sleeve in both closed and open positions.

FIG. 2 illustrates one embodiment of a ball launch and detection system attached at a wellhead and being configured for launching one ball at a time according to the present disclosure.

FIG. 3 illustrates another embodiment of a ball launch and detection system attached at a wellhead, configured for sequentially launching multiple balls in ascending diametrical order, according to the present disclosure.

FIG. 4 illustrates another embodiment of a multiple ball launch and detection system like that of FIG. 3, with two ball launch units attached one atop the other and configured for sequentially launching multiple balls in ascending diametrical order, according to the present disclosure.

FIG. 5A illustrates one embodiment of a ball having a pair of detectable devices installed in it, according to the present disclosure.

FIG. 5B provides a close-up, partial sectional view of the ball of FIG. 5A, showing an RFID tag disposed in a recess in the ball.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

Illustrative embodiments are described below as they might be employed in a wellhead ball launch and detection system and method. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Further aspects and advantages of the various embodiments will become apparent from consideration of the following description and drawings. These embodiments are described in sufficient detail to enable those skilled in the art to practice what is disclosed, and it is to be understood that modifications to the various disclosed embodiments may be made, and other embodiments may be utilized, without departing from the scope of the present disclosure. The following detailed description is, therefore, not to be taken in a limiting sense.

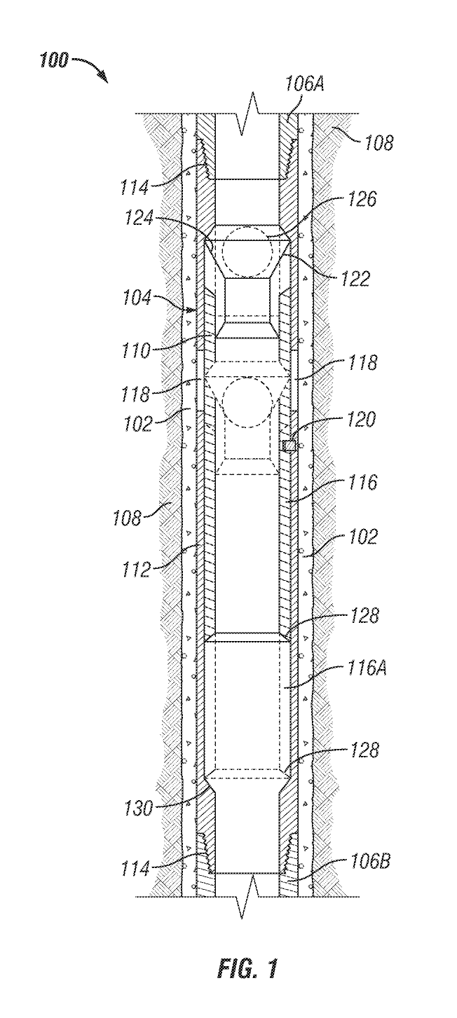

Oil and gas well completions are commonly performed after drilling hydrocarbon-producing well holes. FIG. 1 illustrates a portion of a wellbore completion, indicated generally at 100, wherein cement lining 102 fills the annular space between the well casing 104, which includes multiple lengths of tubular casing, indicated generally at 106A, 106B, that are mechanically attached together with helical threads, and the rock strata 108 in which the well was drilled. The cement lining 102 can be of a dissolvable cement material, which can be dissolved by treating fluid to allow fluid communication with the surrounding rock strata 108, as discussed in more detail below. The well casing 104 can include multiple casing lengths 106A and 106B, which can be connected by collars, pup joints, and other devices.

Installed well casings can also include any of a variety of ball-actuated devices. Ball-actuated devices are down-hole tools that can be incorporated into a well casing string, and are capable of mechanical adjustment or actuation by the physical contact of balls that are introduced into the well casing and pushed with hydraulic pressure. One type of ball actuated device sown in FIG. 1 is a slidable sleeve assembly 110. The slidable sleeve includes an outer casing 112 that is attached to its adjacent well casing sections 106 via helical threads 114. Disposed within the outer casing 112 is an inner sleeve 116 that is slidable between a first closed position, shown in solid lines in FIG. 1, and a second open position, designated 116A and shown in dashed lined in FIG. 1. In the closed position, the inner sleeve 116 blocks a group of ports 118 that extend through the outer casing 112 of the slidable sleeve assembly 110, preventing fluid communication from the interior of the sleeve to the cement lining 102 and the surrounding rock strata 108. The inner sleeve is held in the closed position by a metal pin 120.

The inner sleeve 116 includes a ball seat 122, which is a circular ring having sloped or curved bearing surfaces 124 of a given minimum diameter. The ball seat is designed to receive and intercept a ball of a given diameter, but to allow balls of a smaller diameter to pass through. When a ball of the appropriate diameter, shown at 126, is introduced into the well, it is transported to the site of the corresponding ball seat by the flow of fluid (e.g. fracturing fluid) pumped into in the well. Once the ball 126 reaches the ball seat 122, it is stopped and seals the interior of the well casing, so that continued pumping of the fluid will gradually increase pressure above the ball, while pressure below the ball remains largely unchanged.

This pressure differential gradually increases mechanical force on the ball 126, until this force becomes sufficient to actuate the slidable sleeve. Specifically, after the ball 126 fits into the ball seat 122, increased pressure above the ball will eventually create enough force on the ball to shear the metal pin 120, allowing the inner sleeve to slide downward to the open position. In one exemplary slidable sleeve device, a fluid pressure of around 2000 psi is usually sufficient to actuate the device. When actuated, the inner sleeve 116 slides downward until the distal end 128 of the inner sleeve 116 contacts a shoulder 130 on the inside of the outer casing 112. This is the open position of the slidable sleeve assembly, and is shown in dashed lines in FIG. 1. In the open position, the ports 118 are unblocked, allowing fluid pressure inside the well casing to directly bear against the cement lining 102 of the well and the surrounding rock strata 108 to allow a conventional fracturing operation.

Ball seat-actuated sliding sleeves, like that shown in FIG. 1, can be selectively opened to allow stimulation of production at the location of the sleeve, such as through fracturing. Those of skill in the art will be aware that the treating fluid that is pumped into a well in a typical ball drop operation is typically water with a small quantity of chemicals added to control viscosity, and may also include added salts and surfactants. The treating fluid can also include a solvent that dissolves the cement liner 102 upon opening the sleeve assembly 110, and thereby permits fracturing of the surrounding strata 108. Once the sliding sleeve is opened, the wellbore will communicate with the cement lining 102 surrounding the well casing, allowing the treating fluid to dissolve the cement lining. Thereafter, the well casing will be in fluid communication with the strata 108 surrounding the lining at the location of the sleeve, and increased hydraulic pressure can then fracture the formation adjacent the opened sleeve, potentially permitting better production of hydrocarbons from the strata. A proppant containing slurry (i.e. containing granules of sand, etc.) may be pumped in following the treating fluid to extend and support the fractures that have been created. Once the formation has been fractured at the location of the sleeve, a next larger size ball can be dropped down the string to land in the ball seat of the next higher module, and the process can be repeated.

While the configuration shown in FIG. 1 and described above involves a well completion with a cement liner, it is to be understood that ball-actuated devices are also used in open-hole wells—wells that do not include a cement liner between the well casing and surrounding strata. Many ball drop and sleeve systems are used in open-hole wells, and it is to be understood that the systems and methods disclosed herein can be used both in open-hole wells and wells with cement liners.

It is also to be understood that the slidable sleeve assembly shown in FIG. 1 and described herein is only one example of a ball seat-actuated device. The apparatus and methods disclosed herein are not limited to this type of ball seat-actuated device, but can be used with many other types of ball seat-actuated devices that are used in wellbores. Once the desired operation with the ball seat-actuated device is complete, the ball can be later removed by drilling it out of the well casing. Balls that are used for downhole ball seat-actuated devices are often made of phenolic resin, which is hard and durable enough to withstand the high pressures in the well, dense enough to drop through the fluid in the well (e.g. having a specific gravity that is greater than that of water) but soft enough to be easily drilled out of a well using conventional tools.

In a given well casing string, ball actuated devices, such as this sliding sleeve, can be placed in decreasing order of ball seat diameter, so that the ball actuated device with the largest ball seat is nearest the top of the well, and the device with the smallest ball seat is toward the bottom. This allows the bottommost ball seat-actuated device to be activated first because the smallest ball will pass through the larger ball seats of all devices that are above it. In this way, the ball seat-actuated devices can be sequentially actuated from the bottom of the well to the top, or at any specific desired position in the well.

As noted above, one challenge associated with launching balls into a well is that it can be difficult to confirm that a ball has actually been launched. In the usual practice, the typical mode for confirming launch of a ball is to watch for the subsequent fluid pressure increase in the well, indicating that the ball has sealed its intended ball seat. However, if the pressure does not increase as anticipated, there can be several possible causes, only one of which is failure of the ball to launch. In many cases, direct confirmation that a given ball has launched is only possible by dropping the well fluid pressure, and opening the valve on the wellhead for visual inspection.

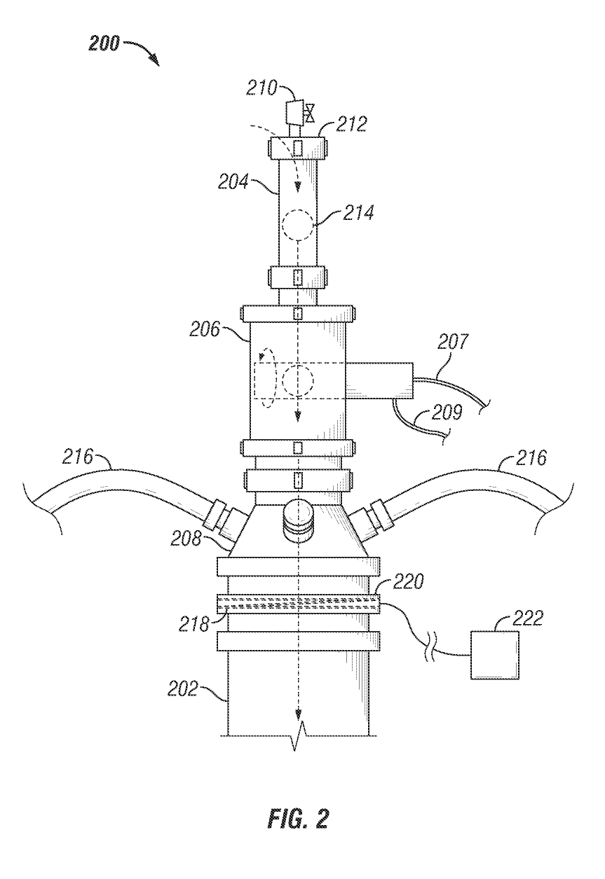

Advantageously, the present disclosure teaches apparatus and methods that have been developed for directly detecting and confirming the drop of balls into a well. Shown in FIG. 2 is one embodiment of a ball launch and detection system, indicated generally at 200, attached to a wellhead 202. This ball launch system generally includes a ball launch tool including an openable pup joint 204, attached atop a plug valve 206, which in turn is attached to a multi-entry head 208 that is positioned atop the wellhead 202. The pup joint provides an openable chamber that is adapted for introduction of a single ball into the wellhead. The plug valve can be a remotely actuable hydraulic valve, having a hydraulic line 207 and control signal line 209 for allowing remote actuation by a user or an automatic system. Alternatively, the plug valve can be a manually actuable valve.

The ball launch system 200 shown in FIG. 2 is configured for launching one ball at a time. To initiate the process of launching a ball, the plug valve 206 is first placed in the closed position, so as to isolate the pup joint 204 from the pressure in the multi-entry head 208. Fluid pressure in the pup valve is then released via a release valve 210 that sits atop the pup joint. Once the pressure in the pup joint has been released, a top cap 212 of the pup joint is opened, and a ball 214 of a desired size is inserted into the pup joint.

Upon insertion of the ball 214 into the pup joint 204, the ball will naturally sink down, under the force of gravity, into the upper portion of the plug valve 206. In addition to being a valve, the plug valve also functions as an actuator that allows the ball to be dropped at will. After the cap 212 of the pup joint 204 is replaced, the plug valve 206 is then opened (either manually or automatically), simultaneously allowing the ball to drop, again, under the force of gravity, through the plug valve 206 and into the multi-entry head 208, and also allowing the pressure to equalize between the multi-entry head 208 and the pup joint 204. After the ball 214 drops into the multi-entry head, it will continue down into the wellhead 202. Ball drop operations are normally performed while pumping treating fluid into the well, such as via one or more treating lines 216 that are attached to the multi-entry head. Consequently, the ball will initially drop under the force of gravity, but once reaching the multi-entry head, the flow of fluid that is being pumped into the wellhead will act to push the ball into the well, and further progress of the ball will not rely on gravity alone. This is particularly desirable given that many oil and gas wells have horizontal portions, wherein gravity would not be sufficient to move the ball.

It will be apparent that the time required for a given ball to reach its corresponding ball seat will vary, depending on the depth to that ball seat, the flow rate of fluid being pumped into the well, and other factors. The rate of pumping can vary. For example, the flow rate can be slowed down to let the ball drop. Typically, the rate may be as high as 100 BPM before the ball drop, but this is then reduced as the ball drop device is opened and the ball is dropped. The rate can then be increased to convey the ball to the location of the ball seat-actuated device, and then reduced again (e.g. to about 10 BPM). Once the ball reaches the ball seat actuated device, the ball will seal the casing at that point, and fluid pressure will begin to rise, eventually applying enough force on the ball to actuate the ball seat-actuated device. Reducing the flow rate as the ball approaches the ball seat-actuated device allows the pressure increase to be more easily seen and detected. Once the pressure has increased, indicating that the device has been actuated (e.g. the sleeve has been shifted), the flow rate can then be increased again to a desired higher rate. The volume of fluid that is needed to reach a ball seat-actuated device will vary, but can be as much as 300 bbls. Naturally, the flow rate will affect the time required for the ball to reach the seat.

There have been instances with this type of apparatus in which balls have gotten stuck in the plug valve or other structure, without actually getting into the wellhead. Accordingly, the ball launch apparatus 200 shown in FIG. 2 is provided with an embodiment of a ball detection system. This ball detection system includes a ball detector 218 that is disposed in a detection flange 220 that is positioned below the multi-entry head 208. The ball detector is connected to an output device 222, such as a monitor or display, which electrical signals from the detector and provides output to a user. The ball detector is positioned in a ring around a central aperture, and is configured to detect the passage of detectable balls that pass through the aperture. In one embodiment, the detector is an RFID detector, having a group of conductive windings that can detect the passage of a ball having an RFID tag attached to it.

Those of skill in the art will be aware that RFID stands for Radio-Frequency Identification. RFID provides radio-frequency communication for the exchange of data between a detector (also known as an interrogator or reader) and an electronic tag (also known as a label) attached to an object, for the purpose of identification and tracking. An RFID tag contains two basic parts: an integrated circuit, and an antenna. The integrated circuit is configured for storing and processing information, modulating and demodulating a radio-frequency (RF) signal, and possibly for other specialized functions. The antenna is configured for receiving and transmitting an RF signal between the tag and the reader. Some RFID tags can be read from several meters away and beyond the line of sight of the reader.

There are three basic types of RFID tags: passive RFID tags, which have no power source and require an external electromagnetic field to initiate a signal transmission, active RFID tags, which contain a battery and can transmit signals once an external source (‘Interrogator’) has been successfully identified, and battery-assisted passive (BAP) RFID tags, which require an external source to wake up, but because of the battery assist, have significant higher forward link capability, providing greater range. In the present circumstance, any of the three basic types of RFID tags can be used, though passive RFID tags are the smallest and least expensive, and are suitable for use in a ball launch detection system as disclosed herein. A passive RFID tag, placed in or on balls that are to be dropped, can be activated by the electromagnetic field of the detector 218 while passing through it, and using this power, can very rapidly transmit data to the detector, which will be obtained by the output device 222, providing a positive indication that the ball has successfully dropped into the wellhead. The output device can be a portable computer, display screen, indicator lights, etc.

As used herein, the term “detectable ball” means a ball that has some characteristic that can be detected. While RFID tags provide one such characteristic (a radio frequency signal), other types of detectors and detectable balls can be used. For example, the balls could be provided with a small radioactive element (e.g. a piece of metal), and the detector could be a Geiger counter or other device for detecting the radioactive ball as it passes the detector location. As another alternative, the detector can comprise an induction coil, and the detectable balls could include a ferromagnetic mass, which will produce an induced current upon passage through the detector. Other detector and detectable ball configurations can also be used.

The use of RFID technology is considered desirable because an RFID tag on a ball will not only indicate when the ball passes, but can also provide other data as well. For example, the RFID tag can be programmed with data about the ball in question, such as the size of the ball, the weight of the ball, the date and place of manufacture of the ball, the ball's exact materials of composition, a serial number, etc. Having the ability to provide additional data increases the overall utility of the system by providing more information to a user.

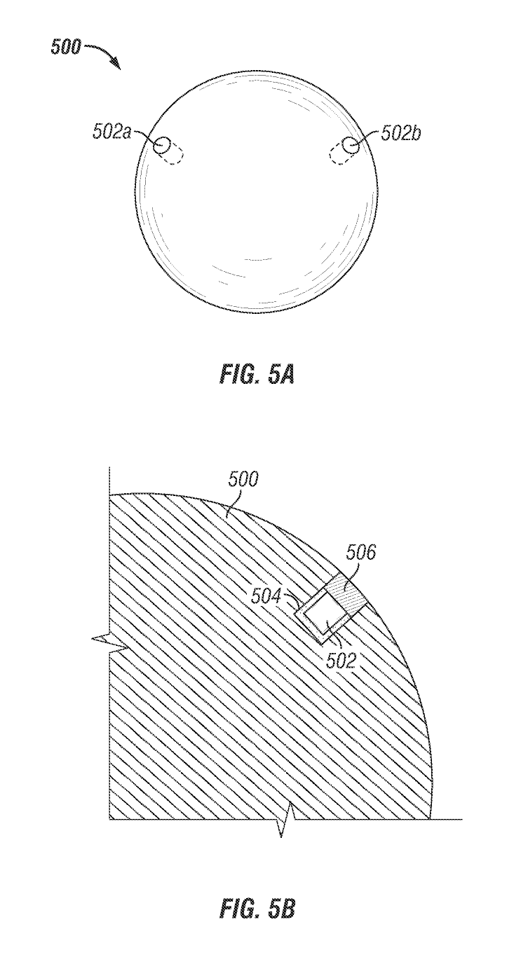

Illustrations of a detectable ball 500 provided with RFID tags 502 are shown in FIGS. 5A and 5B. In the embodiment of FIG. 5A, the ball 500 includes two RFID tags, 502a, 502b, positioned at spaced-apart locations. Having more than one RFID tag, and having them spaced apart helps ensure that the system functions as desired. For example, multiple tags provide redundancy, in case one tag malfunctions, and the spacing and positioning of multiple tags helps ensure detection, regardless of the orientation of the ball as it passes through the detector. While two RFID tags are shown on each ball in the illustrations herein, a single tag or other detectable device can be used, and more than two tags can also be used on each ball. As shown in FIG. 5B, an RFID tag 502 can be positioned (e.g. cemented) in a small recess or blind hole 504 in a ball 500, and covered over with a patching material 506, such as resin or the like. This positioning will help protect the tag from damage, but keeps it close to the surface of the ball so as to minimize interference with signals being transmitted to and from the tag.

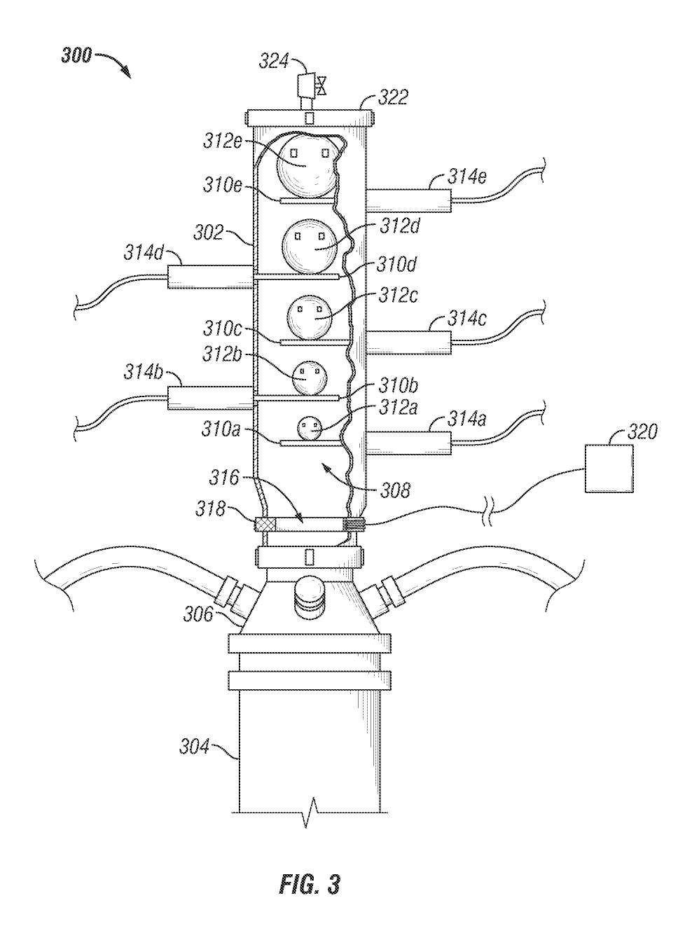

Referring back to FIG. 2, the detector 218 is positioned below the multi-entry head 208 so that the ball 214 will be detected after it enters the stream of fluid being pumped into the wellhead 202. This helps assure that the ball is detected after it can be reasonably presumed that the ball will continue to the desired location in the well casing. It is to be understood, however, that the detector can be placed in other locations relative to the ball launch system and the wellhead, so long as the detector is positioned below the ball drop tool. It can be advantageous to have the detector positioned following a location in which pumped treating fluid enters the well casing, for the reasons given above, but as will be seen with respect to FIG. 3, the detector can also be positioned above a fluid injection point.

The embodiment of FIG. 2 provides a system wherein each ball is individually manually loaded into the ball launch tool. Shown in FIG. 3 is another embodiment of a ball launch and detection system 300 that is configured for loading and launching multiple balls. This ball launch tool generally includes a vessel 302 that is attachable atop a wellhead 304, such as atop a multi-entry head 306 via a hammer union or the like. The vessel has an internal chamber 308 that includes a plurality of selectively releasable ball holders 310, disposed in a substantially vertical array within the internal chamber. Each ball holder is configured to selectively retain a detectable ball 312 in ascending order of ball diameter. Thus, the lowest ball holder 310a is configured to support the smallest ball 312a, and the highest ball holder 310e is configured to hold the largest ball 312e in the group of balls.

The range and incremental size of the balls can vary. In many ball drop operations, the smallest ball will be approximately 1½″ in diameter, and the largest ball will be around 3½″, with balls being made in ¼″ size increments.

In one embodiment, each ball holder 310 is a retractable rod that extends across the interior of the internal chamber 308, though other configurations can also be used. Each ball holder includes an actuator 314, which can be a manually releasable actuator, such as a pin puller, or a power releasable actuator, such as a pneumatic or hydraulic piston. As shown in FIG. 3, the ball drop actuators can be positioned on alternating exterior sides of the vessel.

Located at the bottom of the vessel 302 is an aperture 316 through which all balls will pass when they are dropped. The internal chamber 308 is in fluid communication with this aperture, which is part of a detector 318 that is configured to detect the passage of detectable balls, in the manner discussed above. Once again, the detectable balls can include RFID tags, programmed with a variety of information about a given ball, and the detector can be an RFID detector. The detector is connected to an output device 320, which receives signals from the detector and provides output to a user, in the manner discussed above.

With the ball launch tool 300 shown in FIG. 3, the top of the vessel 302 includes a removable cap 322, which can be a hammer union or the like, with a pressure release valve 324. To load the vessel, the pressure is released through the release valve 324, the hammer union 322 is opened, and the ball holders 310 are all retracted, except for the bottommost ball holder 310a. At that point, the smallest ball 312a can be dropped into the vessel. Then the ball holder 310b that is second from the bottom can be extended, and the second smallest ball 312b can be dropped in, and so on, until the largest ball 312e is put into place. Once all of the balls 312 are positioned in the vessel and retained in place by their respective ball holders 310, the hammer union cap 322 can be replaced, and the vessel 302 can be pressurized.

This configuration places the group of balls 312 within the vessel 302 in ascending diametrical order, allowing them to be sequentially dropped, smallest ball first. This configuration can save time in the ball drop process because there is no need to release pressure, open a chamber, and insert each ball one by one. Instead, and entire group of balls can be installed at one time, and then dropped as needed. In one embodiment, a ball launch tool like that shown in FIG. 3 is approximately 3′ tall and configured to hold six balls, ranging from 1⅞″ diameter to 3½″ diameter. This type of ball launch tool can be configured in other sizes, too, such as for 4 balls, 8 balls, etc. It will be apparent that a maximum size of the largest ball can depend on the diameter of the wellbore itself and any intervening structure.

In another embodiment, aspects of the configurations shown in FIGS. 2 and 3 can be combined. For example, while the embodiment of FIG. 3 includes the detector 318 incorporated into the bottom of the vessel 302, an alternative configuration like that of FIG. 2 could be adopted, with the detector disposed in a detection flange that is below the vessel 302. In FIG. 2 the ball detector 218 is disposed in a detection flange 220 that is positioned below the multi-entry head 208. Referring back to FIG. 3, so long as the detector 318 is disposed below the selectively releasable ball holders 310, it will be able to detect a ball that has been dropped. As noted above, one possible advantage to having the detector positioned below a multi-entry head is that detection of the ball can occur after the ball has entered a stream of fluid being pumped into the well, rather than before the ball enters that stream.

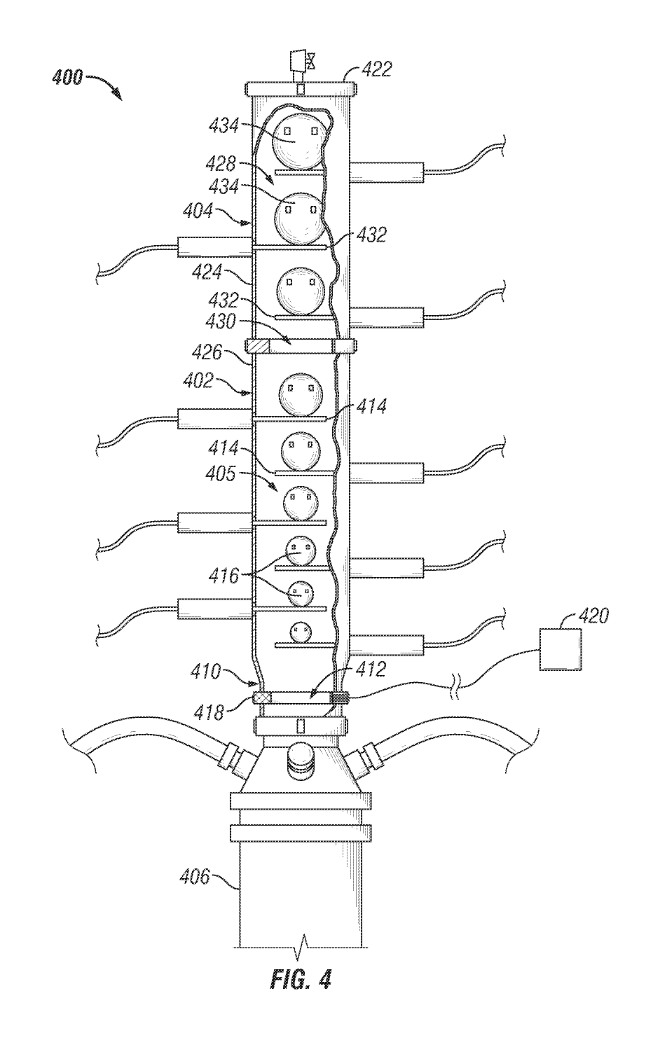

Shown in FIG. 4 is another embodiment of a multiple ball launch and detection system 400. This system is like that of FIG. 3, but it includes two ball launch tools 402, 404 attached one atop the other. The vertically connected ball launch tools are configured for sequentially launching multiple balls in ascending diametrical order, according to the present disclosure.

In this embodiment, the lower ball launch tool 402 is similar to that shown in FIG. 3, and is a generally upright, pressurizable vessel that is attachable to a wellhead 406. As discussed above, this first vessel 402 has an openable top 408, which can be a hammer union or comparable device, a bottom end 410 with an aperture 412, and an internal chamber 405. Within the internal chamber are a plurality of selectively releasable ball holders 414, arranged in a substantially vertical array, and configured to retain a first group of detectable balls 416 in ascending order of ball diameter. A detector 418 is positioned at the aperture 412 at the bottom end of the tool, and is configured to detect passage of the detectable balls as they pass through the aperture 412. The detector is connected to an output device 420, which receives signals from the detector, and provides output to a user.

Advantageously, the ball launch system 400 shown in FIG. 4 is expandable. This embodiment includes a second pressurizable tool 404 that is attachable to the top of the first pressurizable tool 402. Specifically, the hammer union top 408 of the first tool can be removed to allow the second tool to be threaded atop the first tool. Like the first tool 402, the second tool 404 has an openable top 422 (e.g. a hammer union or the like) for loading balls 434, and a bottom end 424 that is attachable to the top 426 of the first pressurizable tool 402, and a second internal chamber 428 with an outlet aperture 430 at the bottom end and in communication with the internal chamber 405 of the first pressurizable tool 402. The second tool 404 includes a second group of selectively releasable ball holders 432, arranged in a substantially vertical array within the second internal chamber 428, configured to retain a second plurality of detectable balls 434 of varying diameter, in ascending order of ball diameter.

Given that the second tool 404 attaches atop the first tool 402, the smallest of the second group of balls 434 will have a diameter that is larger than the largest of the first group of balls 416. With this configuration, a ball released from the second pressurizable tool 404 will drop through the first pressurizable tool 402, and pass through the aperture 412 of the first tool 402 and thus pass through the detector 418 on its way into the wellhead 406.

The stackable tools shown in FIG. 4 provide modularity to a ball injection and detection system. The number of balls to be dropped in a given operation can vary, depending on the depth of the well and the number of ball seat-actuated devices in the well string. Thus, where one well stimulation operation may involve dropping six balls, another such operation may involve dropping twelve balls. Advantageously, modularly stackable ball drop devices like those shown in FIG. 4 can be configured with some common number of balls, but different units having balls in a different size range. For example, two modular units can be configured to hold six balls each, with one unit holding balls in a smaller size range, and another holding balls in a larger size range. Where a drop of twelve balls is needed (or any number between six and twelve), two of these units can be stacked to provide a ball drop tool of the desired capacity.

Alternatively, modular ball drop tools having different numbers of balls can also be provided. For example, given that larger balls are also taller, a smaller modular ball drop tool can be configured to hold six balls, while a next larger size ball drop tool of a similar overall height can be configured to hold four balls in the next larger group of size increments.

As another example, a group of modular ball drop units could all be configured to hold and drop four balls. These ball drop units could be of three different types: A, B and C. The type A ball drop unit could hold four balls of the smallest size, ranging from 1¾″ diameter to 2½″ diameter, in ¼″ increments. The type B ball drop unit could hold four balls ranging from 2¾″ to 3½″ diameter. The type C ball drop unit could hold another four balls ranging in size from 3¾″ to 4½″ diameter. In any combination of use, the smaller ball drop unit(s) will occupy the lower position(s), and all of the ball drop units can be sized to allow the largest balls to pass through them. Thus, depending on well size and the number and size of ball seat-actuated devices, these three modular units can be used individually, or in any of the following combinations (with the smaller unit indicated first): AB, BC, AC, ABC.

Although various embodiments have been shown and described, the present disclosure is not so limited, and will be understood to include all such modifications and variations as would be apparent to one skilled in the art. For example, equivalent elements may be substituted for those specifically shown and described, certain features may be used independently of other features, and the number and configuration of various vehicle components described above may be altered, all without departing from the spirit or scope of the invention as defined in the claims that are appended hereto.

Such adaptations and modifications should and are intended to be comprehended within the meaning and range of equivalents of the disclosed exemplary embodiments. It is to be understood that the phraseology of terminology employed herein is for the purpose of description and not of limitation. Accordingly, the foregoing description of the exemplary embodiments of the invention, as set forth above, are intended to be illustrative, not limiting. Various changes, modifications, and/or adaptations may be made without departing from the spirit and scope of this disclosure.

What is claimed is:

1. A wellhead ball launch detection system, comprising:
a detectable ball; and
a detector, attachable to a wellhead, having an aperture, configured to detect passage of the detectable ball therethrough.

2. A wellhead ball launch detection system in accordance with claim 1, further comprising a ball launch tool, disposed above the detector, adapted to receive the detectable ball for introduction into the wellhead.

3. A wellhead ball launch detection system in accordance with claim 2, wherein the ball launch tool comprises an openable chamber, adapted for introduction of a single detectable ball into the wellhead.

4. A wellhead ball launch detection system in accordance with claim 2, wherein the ball launch tool comprises:
a vessel, having an internal chamber in fluid communication with the aperture of the detector; and
a plurality of selectively releasable ball holders, disposed in a substantially vertical array within the internal chamber, each ball holder being configured to selectively retain a detectable ball in ascending order of ball diameter.

5. A wellhead ball launch detection system in accordance with claim 4, further comprising an actuator, associated with each ball holder, the actuator being selected from the group consisting of a manually releasable actuator, and a power releasable actuator.

6. A wellhead ball launch detection system in accordance with claim 5, wherein the actuators are positioned on alternating exterior sides of the vessel.

7. A wellhead ball launch detection system in accordance with claim 1, wherein the detectable balls include a radio frequency identification (RFID) tag, and the detector comprises an RFID detector.

8. A wellhead ball launch detection system in accordance with claim 7, wherein the radio frequency identification tag is programmed with data representing at least one of the size of the ball, the weight of the ball, and the date of manufacture of the ball.

9. A wellhead ball launch detection system in accordance with claim 1, wherein the detectable ball includes multiple radio frequency identification tags.

10. A wellhead ball launch detection system in accordance with claim 1, wherein the detectable ball comprises a detectable device attached within a surface aperture of the ball.

11. A wellhead ball launch system, comprising:
a generally upright, first pressurizable tool, attachable to a wellhead, having an openable top, and an internal chamber;
a plurality of selectively releasable ball holders, arranged in a substantially vertical array within the internal chamber, configured to retain a first plurality of detectable balls of varying diameter, in ascending order of ball diameter; and
a detector, having an aperture, disposed below all of the selectively releasable ball holders, configured to detect passage of a detectable ball therethrough.

12. A wellhead ball launch system in accordance with claim 11, wherein the selectively releasable ball holders each include an actuator, selected from the group consisting of a manual release, and a power-actuable release.

13. A wellhead ball launch system in accordance with claim 12, wherein the actuators are positioned on alternating exterior sides of the pressurizable tool.

14. A wellhead ball launch system in accordance with claim 1, wherein the detectable ball includes a radio frequency identification (RFID) tag, and the detector comprises an RFID detector.

15. A wellhead ball launch system in accordance with claim 14, wherein the radio frequency identification tag is programmed with data representing at least one of the size of the ball, the weight of the ball, and the date of manufacture of the ball.

16. A wellhead ball launch system in accordance with claim 11, wherein the detectable ball includes multiple radio frequency identification tags.

17. A wellhead ball launch system in accordance with claim 11, further comprising:
a second pressurizable tool, having an openable top, a bottom end that is attachable to the top of the first pressurizable tool, and a second internal chamber with an outlet aperture at the bottom end and in communication with the internal chamber of the first pressurizable tool; and
a second plurality of selectively releasable ball holders, arranged in a substantially vertical array within the second internal chamber, configured to retain a second plurality of detectable balls of varying diameter in ascending order of ball diameter, the smallest of the second plurality of balls having a diameter that is larger than the largest of the first plurality of balls;
wherein a ball released from the second pressurizable tool can drop through the first pressurizable tool and pass through the aperture of the detector.

18. A method for launching balls into a wellhead, comprising:
introducing a detectable ball into a wellhead tool; and
detecting passage of the detectable ball from the tool, thereby confirming that the ball has dropped into the wellhead.

19. A method in accordance with claim 18, wherein the step of introducing the detectable ball comprises introducing a ball having a radio frequency identification (RFID) tag associated therewith, into the wellhead tool, and the step of detecting passage of the detectable ball comprises detecting passage of the RFID tag through an RFID detector.

20. A method in accordance with claim 18, wherein the step of introducing the detectable ball into the wellhead tool comprises sequentially dropping detectable balls from a ball launch tool containing a plurality of detectable balls in ascending diametrical order.
